(19) United States
(12) Patent Application Publication
(10) Pub. No.: US 2004/0149093 A1
(43) Pub. Date: Aug. 5, 2004

(54) TOOL FOR FORMING AN UNDERCUT HOLE AND METHOD FOR ITS USE

(76) Inventor: Gordon Tang, Bellevue, WA (US)

Correspondence Address: Robert M. Storwick, PO Box 386, Mercer Island, WA, 98040, US

(21) Appl. No.: 10/355,679

(22) Filed: Jan. 30, 2003

(51) Int. Cl. B23B 1/00

(52) U.S. Cl. 82/1.2

(57) ABSTRACT

A method and apparatus for forming an undercut hole. The apparatus includes a shaping means attached to a shaft for causing the shaping means to rotate. The shaping means is forced into an initial hole in a piece of material. The rotation of the shaping means causes an undercut hole to be formed at the location of the distal end of the initial hole.

© Copyright 2003, Robert M. Storwick. All rights reserved.

A portion of the disclosure of this patent document contains material that is subject to copyright protection. The copyright owners have no objection to the facsimile reproduction by anyone of the patent document or the patent disclosure, as it appears in the Patent and Trademark Office patent files or records, but otherwise reserve all copyrights whatsoever.

### TECHNICAL FIELD

The present invention relates to methods and apparatus for cutting or grinding material. More particularly, the present invention relates to methods and apparatus for forming an undercut hole in a piece of material.

### BACKGROUND OF THE INVENTION

From time to time, it is helpful to secure a pin solidly into a piece of material. It is known to force a tapered pin into a hole that has been drilled for that purpose, or to adhere a pin in the hole (by various means known to those skilled in the relevant arts, such as adhesives, welding, soldering, brazing, and so forth.). However, it is desirable to have a method and apparatus to secure an expanding pin into an undercut hole that has been formed in the material.

### SUMMARY OF THE INVENTION

According to one aspect, the invention is a method for drilling an undercut hole in a surface of a material. The undercut hole has a first cylindrical portion adjacent the surface and a second axially symmetric undercut portion displaced from the surface. The two portions are coaxial. The first cylindrical portion has a radius R_{H}, and the second axially symmetric undercut portion has a maximum radius R_{HMAX} and a minimum radius R_{Hmin}, where R_{H}≦R_{Hmin}<R_{HMAX}.

The method includes the step of a) forming a shaping member on a distal end of a cylindrical shaft. The shaft has a maximum radius of R_{S}, and the tool has minimum and maximum external radial extensions of R_{Tmin} and R_{TMAX} relative to the axis of the shaft, respectively, where R_{Tmin}≦R_{S}≦R_{TMAX} and R_{H}≦(R_{Tmin}+R_{TMAX})/2.

The method also includes the step of b) drilling a first hole in the material. The first hole has a radius that is equal to or slightly less than (R_{Tmin}+R_{TMAX})/2.

The method further includes the steps of c) forcing the tool to the bottom of the first hole, and d) rotating the tool in the hole to create the undercut hole.

According to a second aspect, the invention is an apparatus for drilling an undercut hole in a surface of a material. The undercut hole has a first cylindrical portion adjacent the surface and a second axially symmetric undercut portion displaced from the surface. The two portions are coaxial. The first cylindrical portion has a radius R_{H}, and the second axially symmetric undercut portion having a maximum radius R_{HMAX} and a minimum radius R_{Hmin}, where R_{H}≦R_{Hmin}<R_{HMAX}.

The apparatus includes means for forming a shaping member on a distal end of a cylindrical shaft. The shaft has a maximum radius of R_{S}. The tool has minimum and maximum external radial extensions of R_{Tmin} and R_{TMAX} relative to the axis of the shaft, respectively, where R_{Tmin}≦R_{S}≦R_{TMAX} and R_{H}≦(R_{Tmin}+R_{TMAX})/2;

The apparatus further includes means for drilling a first hole in the material. The first hole has a radius that is equal to or slightly less than (R_{Tmin}+R_{TMAX})/2.

The apparatus also includes means for forcing the tool to the bottom of the first hole, and means for rotating the tool in the hole to create the undercut hole.

According to a third aspect, the invention is an apparatus for drilling an undercut hole in a surface of a material. The undercut hole has a first cylindrical portion adjacent the surface and a second axially symmetric undercut portion displaced from the surface. The two portions are coaxial. The first cylindrical portion has a radius R_{H}, and the second axially symmetric undercut portion has a maximum radius R_{HMAX} and a minimum radius R_{Hmin}, where R_{H}≦R_{Hmin}<R_{HMAX}.

The apparatus includes a shaping member on a distal end of a cylindrical shaft. The shaft has a maximum radius of R_{S}. The tool has minimum and maximum external radial extensions of R_{Tmin} and R_{TMAX} relative to the axis of the shaft, respectively, where R_{Tmin}≦R_{S}≦R_{TMAX} and R_{H}≦(R_{Tmin}+R_{TMAX})/2.

The apparatus also includes a first hole in the material, the first hole having a radius that is equal to or slightly less than (R_{Tmin}+R_{TMAX})/2.

The apparatus further includes means for forcing the tool to the bottom of the first hole, and means for rotating the tool in the hole to create the undercut hole.

### BRIEF DESCRIPTION OF THE DRAWINGS

FIG. 1 is a perspective view of an embodiment of a pin that has been installed through the use of the method and apparatus of the present invention.

FIG. 2 is a perspective view of an embodiment of a pin that can be used in accordance with the method and apparatus of the present invention.

FIG. 3 is a perspective view of a first embodiment of an inventive tool that is exemplary of the apparatus of the present invention.

FIG. 4 is a first cross-sectional view illustrating the use of the first embodiment of the tool in producing an undercut hole in accordance with the method and apparatus of the present invention.

FIG. 5 is a second cross-sectional view illustrating the use of the first embodiment of the tool in producing an undercut hole in accordance with the method and apparatus of the present invention.

FIG. 6 is a third cross-sectional view illustrating the use of the first embodiment of the tool in producing an undercut hole in accordance with the method and apparatus of the present invention.

FIG. 7 is a fourth cross-sectional view illustrating the use of the first embodiment of the tool in producing an undercut hole in accordance with the method and apparatus of the present invention.

FIG. 8 is a cross-sectional view illustrating the installation of the pin of FIG. 1 into an undercut hole produced in accordance with the method and apparatus of the present invention.

FIG. 9 is a perspective view of a second embodiment of an inventive tool that is exemplary of the apparatus of the present invention.

FIG. 10 is a top view of the features of the undercut hole made by the second embodiment of the inventive tool.

FIG. 11 is a top view of a third embodiment of an inventive tool that is exemplary of the apparatus of the present invention.

FIG. 12 is a top view of a fourth embodiment of an inventive tool that is exemplary of the apparatus of the present invention.

FIG. 13 is a schematic view of the features of the undercut hole made by the third and fourth embodiments of the inventive tool.

FIG. 14 is a top view of a fifth embodiment of an inventive tool that is exemplary of the apparatus of the present invention.

FIG. 15 is a schematic view of the features of the undercut hole made by the fifth embodiment of the inventive tool.

### DETAILED DESCRIPTION OF THE PREFERRED EMBODIMENT OF THE INVENTION

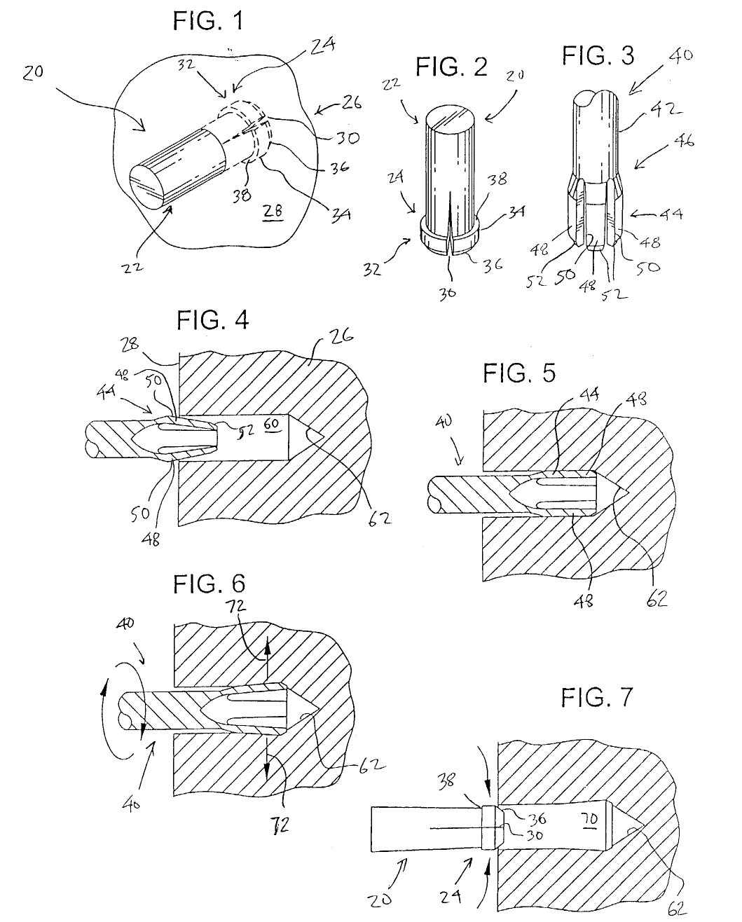

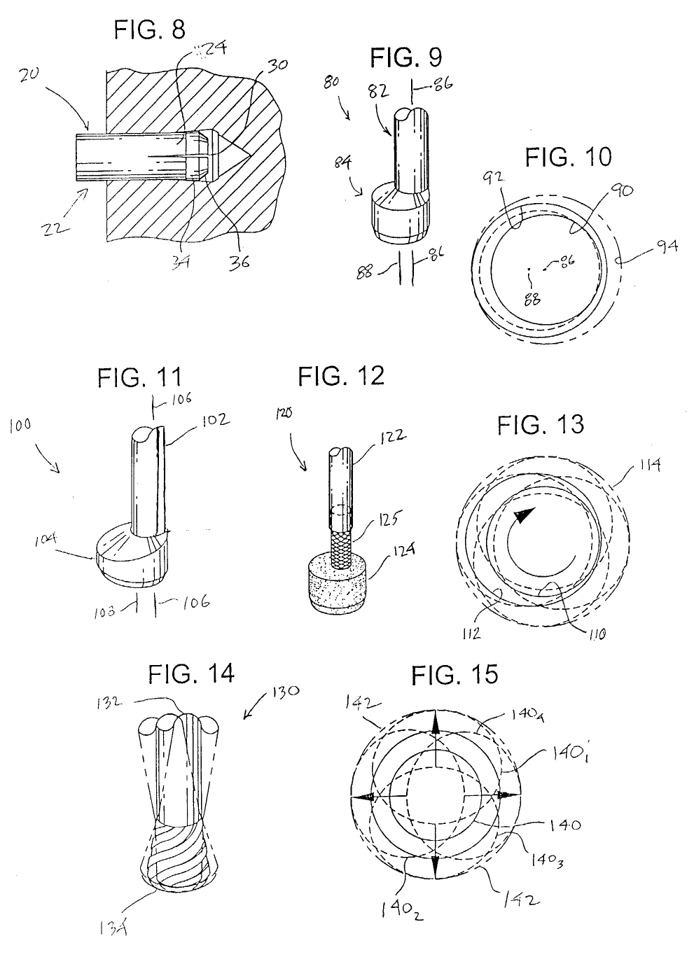

FIG. 1 is a perspective view of an embodiment of a pin that has been installed through the use of the method and apparatus of the present invention, and FIG. 2 is a perspective view of an embodiment of a pin that can be used in accordance with the method and apparatus of the present invention. The pin 20 has an external end 22 and an internal end 24. As shown in FIG. 20, the pin 20 has been installed in a piece of material 26 that has a surface 28. The external end 22 extends outwardly from the surface 28 and the internal end 24 extends inwardly below the surface 28.

The configuration of the pin 20 is used frequently in mechanical applications. These applications include those in which a protrusion from a surface is required, but where the assembly order of the application requires that the protrusion be placed after the application has been at least partially assembled, obviating that the protrusion cannot be made as part of the initial production of the parts of the application. An example of such an application is disclosed in the co-pending United States patent application filed no later than the present application and filed by the inventor of the present application. The external end 22 can be any shape, including an axial shape such as a cylindrical shape, and more specifically, a right cylindrical shape. The internal end 24 is flared outwardly relative to the axial shape of the external end 22. In one particular embodiment, the internal end 24 of the pin 20 can be split, such as by an axial diametric cut 30. Further, the inner perimeter 32 of the internal end 24 can include a circumferential ridge 34 whose innermost edge 36 is tapered and whose outermost edge 38 is an abrupt discontinuity of the outer contour of the pin 20. The innermost edge 36 is tapered to allow the internal end 24 of the pin 20 to be inserted into a hole (not shown in FIGS. 1 or 2) that has been formed in the surface 28 of the material 26. The outermost edge 38 is discontinuous to make removal of the pin 20 difficult after it has been fully inserted into the material 26. The disclosed configuration of the pin 20 is particularly useful if the pin 20 is to be inserted into an undercut hole, i.e., a hole whose distal portion is larger in some sense than its proximal portion.

FIG. 3 is a perspective view of a first embodiment of an inventive tool that is exemplary of the apparatus of the present invention. The tool 40 includes a shaft 42 and a shaping member 44 formed on a distal end 46. The shaft 42 can be cylindrically shaped, and more particularly, be shaped as a right circular cylinder. The shaping member 44 can be used to create an undercut hole in a material 26. The undercut hole will then be appropriate for use with a pin 20 such as that shown in FIGS. 1 and 2.

FIG. 11 is a top view of a third embodiment of an inventive tool that is exemplary of the apparatus of the present invention. In this embodiment, the tool 100 includes a shaft 102 and a cutting portion 104. The shaft 102 has an axis of revolution 106 and the cutting portion 104 has an axis of its center of mass 108. The two axes 106 and 108 are not coincident. As shown in FIG. 13, the circular outline 110 of the shaft 102 is not concentric with the outline 112 of the cutting portion 104. The greatest circumference 114 of the undercut hole 70 includes the outlines of any of the components of the tool 100.

The material that composes the cutting portion 104 can have a fixed density, but a varying longitudinal extent, as shown in FIG. 11. By varying the longitudinal extent of the cutting portion 104 appropriately, the axial stability of the tool 100 can controlled. At one extreme, the tool 100 can be made so that it will rotate about the axis 106 of the shaft 102 without vibration. Alternately, the tool 100 can be made to vibrate to a great extent. Depending upon the application, it may be advantageous for the tool 100 to have no vibrations, so that the cutting action of the tool 100 can be entirely controlled by positioning the axial position of the shaft 102 within the initial hole 60. On the other hand, it may be advantageous for the tool 100 to have relatively large vibrations, so that the cutting action of the tool 100 is caused by the imbalance of the tool 100. As also shown in FIG. 11, a portion of the shaft 102 can extend outwardly beyond the corresponding portion of the tool 100.

FIG. 12 is a top view of a fourth embodiment of an inventive tool that is exemplary of the apparatus of the present invention. In this embodiment, the tool 120 includes a shaft 122, a cutting portion 124 and a flexible cable 125 connecting the shaft 122 to the cutting portion 124. (The cutting portion 124 is shown as a grinding element. It will be understood by those skilled in the relevant arts that any cutting tools disclosed in this specification could equally well be grinding tools, and vice versa. Furthermore, any tools can be any conventional tools known to those skilled in the relevant arts.) Because of the presence of the flexible cable 125, the axis of dynamic rotation of the shaft 122 will not be coincident with the axis of dynamic rotation of the cutting portion 124. Since the cutting portion 124 will be only loosely coupled to the motions of the shaft 122, the cutting portion 124 will wobble within the initial hole 60, allowing the cutting portion 124 to create the undercut hole. Again, as shown in FIG. 13, the circular outline 110 of the shaft 122 is not concentric with the outline 112 of the cutting portion 124. The greatest circumference 114 of the undercut hole 70 includes the outlines of any of the components of the tool 120.

FIG. 13 is a schematic view of the features of the undercut hole made by the third and fourth embodiments of the inventive tool.

FIG. 14 is a top view of a fifth embodiment of an inventive tool that is exemplary of the apparatus of the present invention. In this embodiment, the tool 130 has a shaft 132 and a cutting portion 134. As shown by the phantom lines, once the tool 130 has been inserted into the initial hole 60, the tool 130 can be made to wobble, creating the undercut hole 70.

FIG. 15 is a schematic view of the features of the undercut hole made by the fifth embodiment of the inventive tool. As shown in FIG. 15, the circular outline 140 of the tool 130 can rotate to alternate positions 1401, 1402, 1403 and 1404. The greatest circumference 142 of the undercut hole 70 includes the outlines of any of the components of the tool 130.

While the foregoing is a detailed description of the preferred embodiment of the invention, there are many alternative embodiments of the invention that would occur to those skilled in the art and which are within the scope of the present invention. Accordingly, the present invention is to be determined by the following claims.

The tool 40 (and more particularly, the shaping member 44) can take a large variety of forms in accordance with the invention, as will be understood by those skilled in the relevant arts. As shown in FIG. 3, the shaping member 44 of the tool 40 can be a cutting tool (or shaping member) having a plurality of substantially identical segments 48, each having one or more cutting edges 50. The segments 48 can be created by a plurality of axial diametric cuts; this permits the segments 48 to flex plastically toward the axis of the tool 40, so that the tool 40 will fit into a hole that is smaller than the hole that the tool 40 is capable of forming. Each of the segments 48 has a beveled edge 52 that permits the tool 40 to be inserted into an initial hole that has been formed in the material 26.

The undercut hole with which the tool 40 can be used has a first cylindrical portion adjacent the surface 28 of the material 26 and a second axially symmetric undercut portion displaced from the surface 28 of the material 26. The first cylindrical portion of the hole has a radius R_{H} and the second axially symmetric undercut portion has a maximum radius R_{HMAX} and a minimum radius R_{Hmin}, where R_{H}≦R_{Hmin}<R_{HMAX}.

In general, the shaft 42 has a radius R_{S} and the shaping member has minimum and maximum external radial extensions of R_{Rmin} and R_{TMAX}. These dimensions satisfy the requirement that

R_{Tmin}≦R_{S}≦R_{TMAX}.

FIGS. 4-7 are first, second, third and fourth cross-sectional views illustrating the use of the first embodiment of the tool in producing an undercut hole in accordance with the method and apparatus of the present invention. As shown, the initial hole 60 is formed. The initial hole 60 can be formed by a conventional drill bit having a tapered leading cutting portion, creating a conical innermost surface 62. The tool 40 is initiated into the initial hole 60 by use of the beveled edges 52, causing the segments 48 of the tool 40 to flex plastically toward the axis of the tool 40.

After the tool 40 has been inserted into the initial hole 60, the tool 40 can then be pushed forward until it bottoms out in the initial hole 60 (FIG. 5). After the tool 40 bottoms out, it is caused to rotate (FIG. 6), thereby forming an undercut hole 70 (FIG. 7). Then, after removal of the tool 40 from the undercut hole 70, a pin 20 is inserted, the internal end 24 of the pin 20 being compressed so that the axial diametric cuts 30 are closed. This allows the pin 20 to be fully inserted into the hole 60.

FIG. 8 is a cross-sectional view illustrating the installation of the pin of FIG. 1 into an undercut hole produced in accordance with the method and apparatus of the present invention. As the pin 20 is inserted into the hole 60, the segments 48 expand radially outward (as shown by arrows 72) until, when the pin 20 is fully inserted, they have plastically expanded fully to their original relative positions.

FIG. 9 is a perspective view of a second embodiment of an inventive tool that is exemplary of the apparatus of the present invention, and FIG. 10 is a top view of the features of the undercut hole made by the second embodiment of the inventive tool. In this embodiment, the tool 80 includes a shaft 82 and a cutting portion 84. The shaft 82 has an axis of revolution 86 and the cutting portion 84 has an axis of its center of mass 88. The two axes 86 and 88 are not coincident. As shown in FIG. 10, the circular outline 90 of the shaft 82 is not concentric with the outline 92 of the cutting portion 84. The greatest circumference 94 of the undercut hole 70 includes the outlines of any of the components of the tool 80.

The entire periphery of the cutting portion 84 can have a fixed longitudinal extent, as shown in FIG. 9. However, by varying the density of the material in the cutting portion 84 appropriately, the axial stability of the tool 80 can controlled. At one extreme, the tool 80 can be made so that it will rotate about the axis 86 of the shaft 82 without vibration. Alternately, the tool 80 can be made to vibrate to a great extent. Depending upon the application, it may be advantageous for the tool 80 to have no vibrations, so that the cutting action of the tool 80 can be entirely controlled by positioning the axial position of the shaft 82 within the initial hole 60. On the other hand, it may be advantageous for the tool 80 to have relatively large vibrations, so that the cutting action of the tool 80 is caused by the imbalance of the tool 80.

1. A method for drilling an undercut hole in a surface of a material, the undercut hole having a first cylindrical portion adjacent the surface and a second axially symmetric undercut portion displaced from the surface, the two portions being coaxial, the first cylindrical portion having a radius R_{H}, and the second axially symmetric undercut portion having a maximum radius R_{HMAX} and a minimum radius R_{Hmin}, where R_{H}≦R_{Hmin}<R_{HMAX}, the method comprising the steps of:
a) forming a shaping member on a distal end of a cylindrical shaft, the shaft having a maximum radius of R_{S}, the tool having minimum and maximum external radial extensions of R_{Tmin} and R_{TMAX} relative to the axis of the shaft, respectively, where R_{Tmin}≦R_{S}≦R_{TMAX} and
R_{H}≦(R_{Tmin}+R_{TMAX})/2;
b) drilling a first hole in the material, the first hole having a radius that is equal to or slightly less than
(R_{Tmin}+R_{TMAX})/2;
c) forcing the tool to the bottom of the first hole; and
d) rotating the tool in the hole to create the undercut hole.

2. The method of claim 1, wherein R_{Tmin}=R_{TMAX}.

3. The method of claim 2, wherein the tool has a pliable forward portion that deforms plastically to fit into the first hole.

4. The method of claim 3, wherein the pliable forward portion of the tool is axially divided into a plurality of segments, each of the segments having a substantially identical shape, at least one of the segments being adapted to cut the material.

5. The method of claim 1, wherein the shaping member is a cutting tool.

6. The method of claim 1, wherein the shaping member is a grinding tool.

7. An apparatus for drilling an undercut hole in a surface of a material, the undercut hole having a first cylindrical portion adjacent the surface and a second axially symmetric undercut portion displaced from the surface, the two portions being coaxial, the first cylindrical portion having a radius R_{H}, and the second axially symmetric undercut portion having a maximum radius R_{HMAX} and a minimum radius R_{Hmin}, where R_{H}≦R_{Hmin}<R_{HMAX}, the apparatus comprising:
means for forming a shaping member on a distal end of a cylindrical shaft, the shaft having a maximum radius of R_{S}, the tool having minimum and maximum external radial extensions of R_{Tmin} and R_{TMAX} relative to the axis of the shaft, respectively, where R_{Tmin}≦R_{S}≦R_{TMAX} and
R_{H}≦(R_{Tmin}+R_{TMAX})/2;
means for drilling a first hole in the material, the first hole having a radius that is equal to or slightly less than
(R_{Tmin}+R_{TMAX})/2;
means for forcing the tool to the bottom of the first hole; and
means for rotating the tool in the hole to create the undercut hole.

8. The apparatus of claim 7, wherein R_{Tmin}=R_{TMAX}.

9. The apparatus of claim 8, wherein the tool has a pliable forward portion that deforms plastically to fit into the first hole.

10. The apparatus of claim 9, wherein the pliable forward portion of the tool is axially divided into a plurality of segments, each of the segments having a substantially identical shape, at least one of the segments being adapted to cut the material.

11. The apparatus of claim 7, wherein the shaping member is a cutting tool.

12. The apparatus of claim 7, wherein the shaping member is a grinding tool.

13. An apparatus for drilling an undercut hole in a surface of a material, the undercut hole having a first cylindrical portion adjacent the surface and a second axially symmetric undercut portion displaced from the surface, the two portions being coaxial, the first cylindrical portion having a radius R_{H}, and the second axially symmetric undercut portion having a maximum radius R_{HMAX} and a minimum radius R_{Hmin}, where R_{H}≦R_{Hmin}<R_{HMAX}, the apparatus comprising:
a shaping member on a distal end of a cylindrical shaft, the shaft having a maximum radius of R_{S}, the tool having minimum and maximum external radial extensions of R_{Tmin} and R_{TMAX} relative to the axis of the shaft, respectively, where R_{Tmin}≦R_{S}≦R_{TMAX} and
R_{H}≦(R_{Tmin}+R_{TMAX})/2;
a first hole in the material, the first hole having a radius that is equal to or slightly less than
(R_{Tmin}+R_{TMAX})/2;
means for forcing the tool to the bottom of the first hole; and
means for rotating the tool in the hole to create the undercut hole.

14. The apparatus of claim 13, wherein R_{Tmin}=R_{TMAX}.

15. The apparatus of claim 14, wherein the tool has a pliable forward portion that deforms plastically to fit into the first hole.

16. The apparatus of claim 15, wherein the pliable forward portion of the tool is axially divided into a plurality of segments, each of the segments having a substantially identical shape, at least one of the segments being adapted to cut the material.

17. The apparatus of claim 13, wherein the shaping member is a cutting tool.

18. The apparatus of claim 13, wherein the shaping member is a grinding tool.
